(19) United States
(12) Patent Application Publication
(10) Pub. No.: US 2013/0071770 A1
(43) Pub. Date: Mar. 21, 2013

(54) HIGH-TEMPERATURE STRUCTURAL MATERIAL, STRUCTURAL BODY FOR SOLID ELECTROLYTE FUEL CELL, AND SOLID ELECTROLYTE FUEL CELL

(71) Applicant: MURATA MANUFACTURING CO., LTD., Nagaokakyo-Shi (JP)

(72) Inventor: Kazuhide Takata, Nagaokakyo-shi (JP)

(21) Appl. No.: 13/669,712

(22) Filed: Nov. 6, 2012

Related U.S. Application Data
(63) Continuation of application No. PCT/JP2011/060235, filed on Apr. 27, 2011.

(30) Foreign Application Priority Data
May 7, 2010 (JP) 2010-107549

(51) Int. Cl. H01M 2/16; H01M 8/24

(52) U.S. Cl. 429/468; 429/509; 252/62

(57) ABSTRACT

A high-temperature structural material which not only has a coefficient of thermal expansion close to the coefficient of thermal expansion of an electrolyte material, but also undergoes no decrease in mechanical strength even in a reducing atmosphere, and can be sintered at relatively low temperatures just by adding a predetermined sintering aid, a structural body for a solid electrolyte fuel cell, which is formed with the use of the high-temperature structural material, and a solid electrolyte fuel cell including the structural body. The high-temperature structural material contains strontium titanate and aluminum, wherein the aluminum is in an amount of 10 parts by mol or more and 60 parts by mol or less with respect to 100 parts by mol of the strontium titanate.

### CROSS REFERENCE TO RELATED APPLICATIONS

The present application is a continuation of International application No. PCT/JP2011/060235, filed Apr. 27, 2011, which claims priority to Japanese Patent Application No. 2010-107549, filed May 7, 2010, the entire contents of each of which are incorporated herein by reference.

### FIELD OF THE INVENTION

The present invention relates to a high-temperature structural material, a structural body for a solid electrolyte fuel cell, which is formed with the use of the high-temperature structural material, and a solid electrolyte fuel cell including the structural body.

### BACKGROUND OF THE INVENTION

In general, flat-plate solid electrolyte fuel cells (also referred to as a solid oxide fuel cells (SOFCs)) are composed of: a plurality of plate-like cells as power generation elements, each including an anode (a negative electrode, a fuel electrode), a solid electrolyte, and a cathode (a positive electrode, an air electrode); and separators placed between the plurality of cells. The separators are intended to electrically connect the plurality of cells in series with each other, and placed between the plurality of cells in order to separate gases supplied to each of the cells, specifically, in order to separate between a fuel gas (for example, hydrogen) as an anode gas supplied to the anode and an oxidant gas (for example, the air) as a cathode gas supplied to the cathode.

Conventionally, the separators are formed from a high heat-resistance metal material, or a conductive ceramic material such as lanthanum chromite (LaCrO₃). The formation of the separators with the use of this type of conductive material can constitute a member which performs the functions of electrical connection and gas separation with one type of material. However, the use of the conductive material such as lanthanum chromite has the problem of increasing the number of manufacturing steps in order to make efforts for co-sintering with the other members constituting the cells. In addition, the use of the conductive material such as lanthanum chromite has the problem of increased manufacturing cost because of expensiveness in maternal cost.

In addition, because the solid electrolyte fuel cells have high operating temperatures, the respective constituent members of the solid electrolyte fuel cells, such as a power generation element constituting cells, a separator member for separating cells from each other and a gas manifold member for separating and supplying gases, have problems with their strengths and coefficients of thermal expansion. In particular, the coefficients of thermal expansion of the respective constituent members are required to be close to the coefficient of thermal expansion of yttrium-stabilized zirconia (YSZ) which is an electrolyte material. However, the coefficients of thermal expansion of the respective constituent members of the solid electrolyte fuel cells in the prior art are not necessarily approximated to the coefficient of thermal expansion of the yttrium-stabilized zirconia, and there has been thus a problem that strain and deformation are caused by the differences in thermal expansion at the operating temperatures.

In contrast, the solid electrolyte fuel cell disclosed in Japanese Patent Application Laid-Open No. 5-275106 (Patent Document 1) has a separator including a separator main body, and an electron flow channel placed so as to penetrate through a separator section of the separator main body. The separator main body is composed of a composite material of MgO and MgAl₂O₄. In this case, the coefficient of thermal expansion of the composite material can be approximated to the coefficient of thermal expansion of YSZ by varying the mixing ratio between MgO and MgAl₂O₄. Thus, this composite material can be applied to the respective constituent members of the solid electrolyte fuel cell, such as the separator.

However, this composite material has poor sinterability, and thus has low reliability in terms of water resistance and carbon dioxide gas resistance. For example, this composite material has the problem of a decrease in mechanical strength, because MgO is selectively eluted in an atmosphere with H₂O or CO₂ present to produce a porous body only of MgAl₂O₄ after long periods of time, even when the composite material is sintered at a temperature of 1500° C. or more.

In order to solve this problem, there is a need to coat the surface of the constituent member composed of the composite material with MgAl₂O₄ or Al₂O₃, as described in Japanese Patent Application Laid-Open No. 6-5293 (Patent Document 2) and Japanese Patent Application Laid-Open No. 6-111833 (Patent Document 3).

Alternatively, in the case of using the separators containing MgO and MgAl₂O₄ as their main constituents, the separator materials, or the separator material and cell material are bonded with the MgO—MgAl₂O₃ composite oxide interposed therebetween. In this case, because of the high melting point of the MgO—MgAl₂O₃ composite oxide, there is a problem that the temperature of 1400° C. or more for bonding by sintering degrades the fuel electrode and air electrode exposed to the high temperature, and thus cause damage to the cell performance.

In order to solve this problem, a bonding material with MgO:SiO₂=1:0.5 to 5 (ratio by weight) is interposed between separator materials or between a separator material and a cell material to achieve bonding at a sintering temperature of 1300° C. or less, as described in Japanese Patent Application Laid-Open No. 8-231280 (Patent Document 4).

### SUMMARY OF THE INVENTION

As described above, in the case of using, as the material of the separator main body, a material including MgAl₂O₄ (magnesia spinel), there is a need to make efforts such as a need to coat the surface of the constituent member in order to prevent the mechanical strength from being decreased, or a need to use a bonding material including SiO₂ in order to bond the separator materials or bond the separator and the cell material at a sintering temperature of 1300° C. or less. For this reason, the increased number of manufacturing step thus increases the manufacturing cost.

Therefore, an object of the present invention is to provide a high-temperature structural material which not only has a coefficient of thermal expansion closed to the coefficient of thermal expansion of an electrolyte material, but also undergoes no decrease in mechanical strength even in a reducing atmosphere, and can be sintered at relatively low temperatures just by adding a predetermined sintering aid, a structural body for a solid electrolyte fuel cell, which is formed with the use of the high-temperature structural material, and a solid electrolyte fuel cell including the structural body.

### Means for Solving the Problem

The inventor has found that, as a result of making various studies for solving the problems mentioned above, the addition of an aluminum oxide to a strontium titanate can reduce the coefficient of thermal expansion, and improve the mechanical strength, as compared with a material only of strontium titanate. In addition, the inventor has found that the addition of a manganese oxide or a niobium oxide as a sintering aid can easily reduce the sintering temperature. The present invention has been achieved on the basis of the findings of the inventors, and has the following features.

A high-temperature structural material according to the present invention contains a strontium titanate and aluminum. The aluminum is present at 10 parts by mol or more and 60 parts by mol or less with respect to 100 parts by mol of the strontium titanate.

The high-temperature structural material according to the present invention preferably further contains a manganese oxide or a niobium oxide.

A structural body for a solid electrolyte fuel cell according to the present invention is a structural body for a solid electrolyte fuel cell, which is placed between or around a plurality of cells each composed of an anode layer, a solid electrolyte layer, and a cathode layer stacked sequentially, in a solid electrolyte fuel cell. The structural body for a solid electrolyte fuel cell includes a main body section composed of an electrical insulation body, and an electron flow channel section formed in this main body section. The main body section is formed from the high-temperature structural material.

In the structural body for a solid electrolyte fuel cell according to the present invention, the main body section and the electron flow channel section are preferably formed by co-sintering.

A solid electrolyte fuel cell according to the present invention includes: a plurality of cells each composed of an anode layer, a solid electrolyte layer, and a cathode layer stacked sequentially; and the structural body for a solid electrolyte fuel cell, which is placed between or around the plurality of cells.

As described above, the present invention can achieve a high-temperature structural material which not only has a coefficient of thermal expansion closed to the coefficient of thermal expansion of an electrolyte material, but also undergoes no decrease in mechanical strength even in a reducing atmosphere, and can be sintered at relatively low temperatures just by adding a predetermined sintering aid, a structural body for a solid electrolyte fuel cell, which is formed with the use of the high-temperature structural material, and a solid electrolyte fuel cell including the structural body.

### BRIEF EXPLANATION OF THE DRAWINGS

FIG. 1 is an exploded perspective view separately illustrating respective members constituting a plate-like solid electrolyte fuel cell as an embodiment of the present invention.

FIG. 2 is an exploded perspective view separately illustrating respective stacked sheets constituting a plate-like solid electrolyte fuel cell as an embodiment of the present invention.

FIG. 3 is a cross-sectional view schematically illustrating a cross section of a plate-like solid electrolyte fuel cell as an embodiment of the present invention.

FIG. 4 is an exploded perspective view separately illustrating respective members constituting a plate-like solid electrolyte fuel cell as an embodiment of the present invention, and as a sample prepared according to an example of the present invention.

FIG. 5 is an exploded perspective view separately illustrating respective stacked sheets constituting a plate-like solid electrolyte fuel cell as an embodiment of the present invention, and as a sample prepared according to an example of the present invention.

FIG. 6 is a cross-sectional view schematically illustrating a cross section of a plate-like solid electrolyte fuel cell as an embodiment of the present invention, and as a sample prepared according to an example of the present invention.

FIG. 7 is a cross-sectional view schematically illustrating a cross section of a plate-like solid electrolyte fuel cell as an example of forming an electrical conductor partially from a material for an electron flow channel section according to the present invention.

FIG. 8 is a cross-sectional view schematically illustrating a cross section of a plate-like solid electrolyte fuel cell as another example of forming an electrical conductor partially from a material for an electron flow channel section according to the present invention.

FIG. 9 is a cross-sectional view schematically illustrating a cross section of a plate-like solid electrolyte fuel cell as another example of forming an electrical conductor partially from a material for an electron flow channel section according to the present invention.

### DETAILED DESCRIPTION OF PREFERRED EMBODIMENTS OF THE INVENTION

The inventor has made considerations from various points of view, in order to achieve a high-temperature structural material which can be applied to a structural body for a solid electrolyte fuel cell placed between or around a plurality of cells each composed of an anode layer, a solid electrolyte layer, and a cathode layer sequentially stacked, and which not only has a coefficient of thermal expansion close to the coefficient of thermal expansion of the electrolyte material, but also undergoes no decrease in mechanical strength even in a reducing atmosphere, and can be sintered at relatively low temperatures.

Based on the considerations, the inventor has considered the use of a strontium titanate as a material for a structural body of a solid electrolyte fuel cell. Strontium titanate is a stable material as used for electronic components such as a dielectric material. However, the strontium titanate has a high coefficient of thermal expansion, and a relatively small mechanical strength for use as a structural material for a solid electrolyte fuel cell. Thus, the inventor found that the addition of an aluminum oxide to a strontium titanate can reduce the coefficient of thermal expansion, and improve the mechanical strength. Furthermore, the inventor has found that the addition of a manganese oxide or a niobium oxide to a composite oxide of the strontium titanate and an aluminum oxide can easily achieve sintering at a temperature of 1300° C. or less. Moreover, the inventor has found that it is possible to bond this composite oxide by co-sintering, together with a solid electrolyte material, a cathode (air electrode) material, and an anode (fuel electrode) material. It is to be noted that in the case of sintering at a low temperature less than 1200° C. with the addition of an aluminum oxide to the strontium titanate, the sintered body obtained at least contains therein aluminum as an aluminum oxide. In addition, in the case of sintering at a high temperature of 1200° C. or more with the addition of an aluminum oxide to the strontium titanate, the sintered body obtained at least contains therein aluminum as a compound of aluminum and strontium, such as, for example, SrAl₁₂O₁₉ or SrAl₈Ti₃O₁₉. The sintered body obtained may have a mix of an aluminum oxide with a compound of aluminum and strontium as described previously.

Based on these findings of the inventor, a high-temperature structural material according to the present invention contains a strontium titanate and aluminum, and the aluminum is present at 10 parts by mol or more and 60 parts by mol or less with respect to 100 parts by mol of the strontium titanate.

The strontium titanate and aluminum oxide constituting the high-temperature structural material according to the present invention is a chemically stable and inexpensive material. In addition, the composite oxide of the strontium titanate and aluminum oxide, or the compound of aluminum and strontium, such as SrAl₁₂O₁₉ or SrAl₈Ti₃O₁₉ has oxidation resistance and reduction resistance. Furthermore, the coefficient of thermal expansion of the material containing aluminum at 10 parts by mol or more and 60 parts by mol or less with respect to 100 parts by mol of the strontium titanate is close to that of yttrium-stabilized zirconia (YSZ) that is a solid electrolyte material. In order to achieve a dense sintered body by co-sintering of the two types of materials, the difference in coefficient of thermal expansion is desirably on the order of 0.6×10⁻⁶/K or less between the different types of materials. For example, zirconia partially stabilized with the addition of 8 mol % of yttria (8YSZ) is used for a solid electrolyte material of a solid electrolyte fuel cell. The 8YSZ has a relatively low coefficient of thermal expansion of 10.5×10⁻⁶/K at a temperature of 1000° C. Because the difference in coefficient of thermal expansion is on the order of 0.6×10⁻⁶/K or less between the high-temperature structural material according to the present invention containing Al₂O₃ at the mole fraction mentioned above and the 8YSZ, it is possible to bond the high-temperature structural material according to the present invention by con-sintering with the 8YSZ.

The high-temperature structural material according to the present invention preferably further contains a manganese oxide or a niobium oxide. Examples of the manganese oxide or niobium oxide include Mn₃O₄ or Nb₂O₅. It is to be noted that the high-temperature structural material according to the present invention produces a similar effect, even in the case of containing a composite oxide with the manganese oxide or niobium oxide partially substituted with other element.

The addition of the manganese oxide or niobium oxide as a sintering aid to the high-temperature structural material according to the present invention makes it possible to achieve a dense sintered body even when the high-temperature structural material according to the present invention is subjected to sintering at a temperature of, for example, 1300° C. or less. The high-temperature structural material preferably contains therein the manganese oxide or niobium oxide at 1.0 mass % or more and 5.0 mass % or less.

In addition, a structural body for a solid electrolyte fuel cell as an embodiment of the present invention is a structural body for a solid electrolyte fuel cell, which is placed between or around a plurality of cells each composed of an anode layer, a solid electrolyte layer, and a cathode layer stacked sequentially, in a solid electrolyte fuel cell. The structural body for a solid electrolyte fuel cell includes a main body section composed of an electrical insulation body, and an electron flow channel section formed in this main body section. The main body section is formed from the high-temperature structural material. It is to be noted that structural body for a solid electrolyte fuel cell may be any of a separator main body for a solid electrolyte fuel cell, a gas manifold main body for a solid electrolyte fuel cell, or a support main body for a solid electrolyte fuel cell. The separator main body is placed between the plurality of cells, and composed of an electrical insulator in order to separate between a fuel gas as an anode gas and the air as a cathode gas, which are supplied to each of the cells. The gas manifold main body is placed between or around the plurality of cells, and composed of an electrical insulator in order to separate between a fuel gas as an anode gas and the air as a cathode gas, and supply the gases to each of the cells. The support main body is composed of an electrical insulator placed around the plurality of cells.

In the structural body for a solid electrolyte fuel cell according to the present invention, the main body section and the electron flow channel section are preferably formed by co-sintering.

Further, a solid electrolyte fuel cell according to the present invention includes: a plurality of cells each composed of an anode layer, a solid electrolyte layer, and a cathode layer stacked sequentially; and the structural body for a solid electrolyte fuel cell, which is placed between or around the plurality of cells.

The configurations of solid electrolyte fuel cells as embodiments of the present invention will be described below with reference to the drawings.

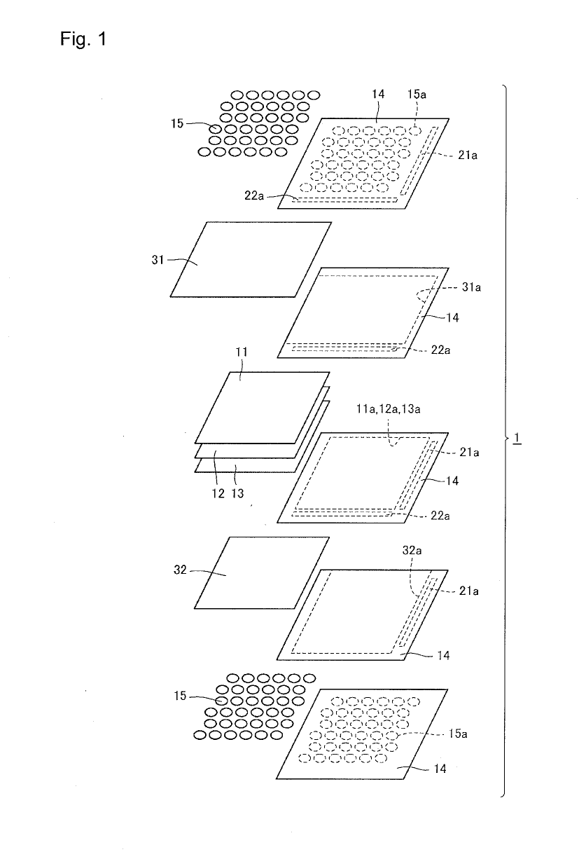

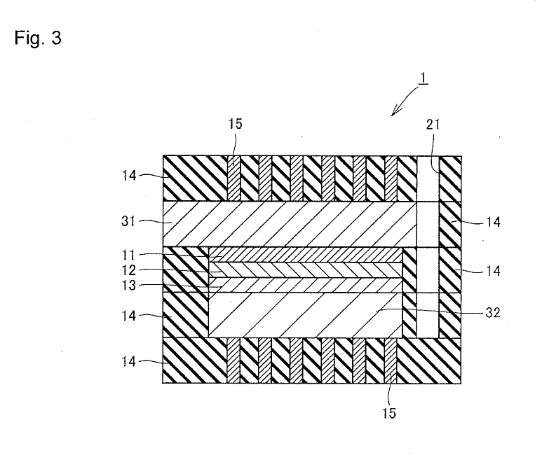

As shown in FIGS. 1 to 3, a solid electrolyte fuel cell 1 as an embodiment of the present invention includes: a plurality of cells composed of a fuel electrode layer 11 as an anode layer, a solid electrolyte layer 12, and an air electrode layer 13 as a cathode layer; and a structural body (separator, gas manifold, support) placed between and around the plurality of cells. The structural body is composed of main body sections 14 composed of electrical insulators for separating between a fuel gas as an anode gas and the air as a cathode gas, which are supplied to each of the cell; and electron flow channel sections (interconnectors) 15 formed in the main body sections 14, and as electrical conductors for electrically connecting the plurality of cells to each other. The main body sections 14 are formed with the use of a material containing a strontium titanate and aluminum, the aluminum being present at 10 parts by mol or more and 60 parts by mol or less with respect to 100 parts by mol of the strontium titanate. The electron flow channel sections 15 are formed with the use of, for example, a ceramic composition represented by the composition formula La(Fe₁₋ₓAlₓ)O₃ (in the formula, x represents a molar ratio, and satisfies 0<x<0.5). In addition, the solid electrolyte fuel cell 1 shown in FIG. 3 is a cell including a single cell, with a structural body placed on both sides of and around the cell. This structural body is composed of main body sections 14 placed on the both sides of and around the cell (between and around the plurality of cells); and electron flow channel sections 15 placed in the main body sections 14. Furthermore, a fuel electrode current collecting layer 31 is placed between a fuel electrode layer 11 and the electron flow channel sections 15, whereas an air electrode current collecting layer 32 is placed between an air electrode layer 13 and the electron flow channel sections 15.

The solid electrolyte fuel cell 1 as an embodiment of the present invention is manufactured as follows.

First, through holes 15a for filling with green sheets for the plurality of electron flow channel sections 15 are formed as indicated by a dashed line in FIG. 1 in green sheets for the main body sections 14 constituting the structural body.

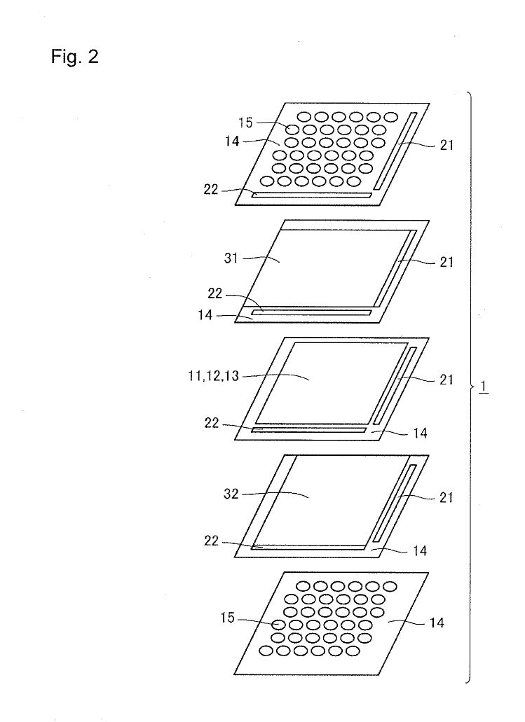

In addition, green sheets for main body sections 14 are each, as indicated by a dashed line in FIG. 1, subjected to punching with the use of a mechanical puncher to form elongated through holes 21a, 22a for forming a fuel gas supply channel 21 and an air supply channel 22 as shown in FIG. 2.

Furthermore, mating sections 11a, 12a, 13a respectively for fitting green sheets for a fuel electrode layer 11, a solid electrolyte layer 12, and an air electrode layer 13 are formed in a green sheet for the main body section 14 with the fuel electrode layer 11, solid electrolyte layer 12, and air electrode layer 13 to be placed thereon.

Moreover, mating sections 31a, 32a respectively for fitting the green sheets for a fuel electrode current collecting layer 31 and an air electrode current collecting layer 32 are formed in the green sheets for the main body sections 14 with the fuel electrode current collecting layer 31 or air electrode current collecting layer 32 to be placed thereon. It is to be noted that the green sheets for the fuel electrode current collecting layer 31 or the air electrode current collecting layer 32 are prepared with the use of the same compositions as the respective material powders of the fuel electrode layer 11 and air electrode layer 13.

For each of the green sheets for the main body sections 14, which are prepared in the way described above, the green sheets for the electron flow channel sections 15; the green sheets for the fuel electrode layer 11, solid electrolyte layer 12, and air electrode layer 13; and the green sheets for the fuel electrode current collecting layer 31 and air electrode current collecting layer 32 are respectively fitted in the through holes 15a; the mating sections 11a, 12a, 13a; and the mating sections 31a, 32a. The five green sheets thus obtained are stacked sequentially as shown in FIG. 2.

The stacked sheets are subjected to pressure bonding by warm isostatic pressing (WIP) at a predetermined pressure and a predetermined temperature for a predetermined period of time. This pressure-bonded body is subjected to a degreasing treatment within a predetermined temperature range, and then to sintering by keeping at a predetermined temperature for a predetermined period of time.

In this way, the solid electrolyte fuel cell 1 is manufactured as an embodiment of the present invention.

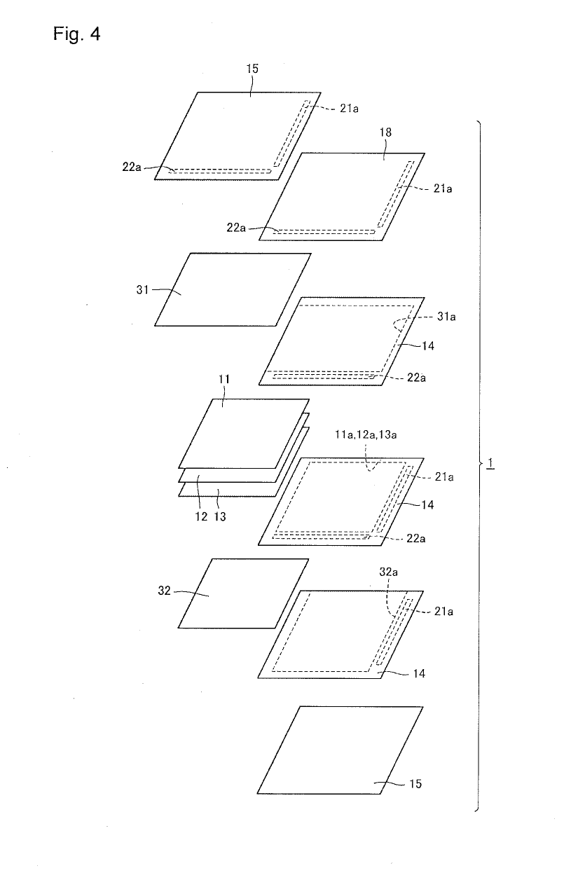

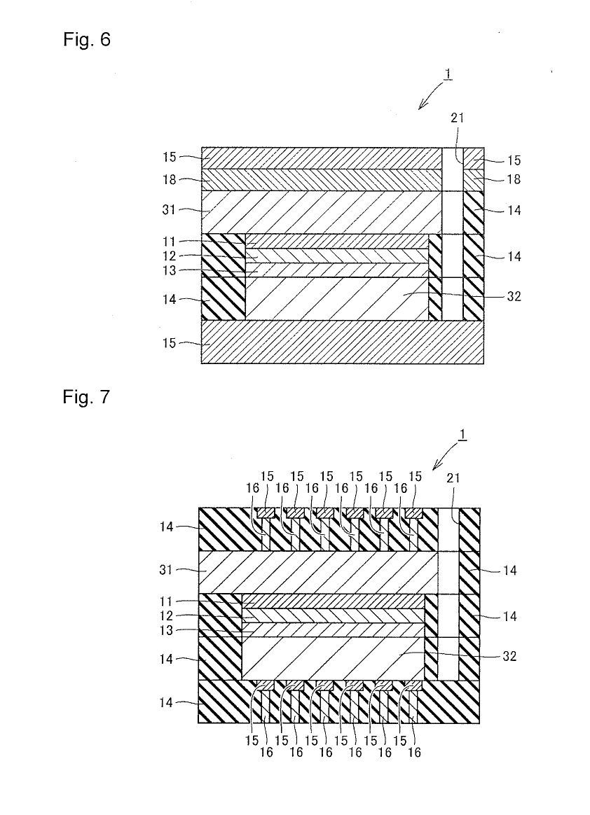

As shown in FIGS. 4 to 6, a solid electrolyte fuel cell 1 as another embodiment of the present invention includes: a plurality of cells composed of a fuel electrode layer 11 as an anode layer, a solid electrolyte layer 12, and an air electrode layer 13 as a cathode layer; and a structural body placed around and between the plurality of cells. In this case, the fuel electrode layer 11 contains nickel. The structural body placed around the plurality of cells is composed of main body sections 14 as electrical insulators for separating between a fuel gas as an anode gas and the air as a cathode gas, which are supplied to each of the cells. The structural body placed between the plurality of cells is composed of electron flow channel sections 15 as electrical conductors for electrically connecting the plurality of cells to each other. The main body sections 14 are formed with the use of a composite oxide containing a strontium titanate and aluminum, the aluminum being present at 10 parts by mol or more and 60 parts by mol or less with respect to 100 parts by mol of the strontium titanate. The electron flow channel sections 15 are formed with the use of, for example, a ceramic composition represented by the composition formula La(Fe₁₋ₓAlₓ)O₃ (in the formula, x represents a molar ratio, and satisfies 0<x<0.5). The solid electrolyte fuel cell 1 shown in FIG. 6 is a cell including a single cell, with a structural body placed on both sides of and around the cell. This structural body is composed of main body sections 14 placed around the cell (around the plurality of cells); and electron flow channel sections 15 placed on the both sides of the cell (between the plurality of cells) in the main body sections 14. Furthermore, a fuel electrode current collecting layer 31 is placed between a fuel electrode layer 11 and the electron flow channel sections 15, whereas an air electrode current collecting layer 32 is placed between an air electrode layer 13 and the electron flow channel sections 15. A fuel electrode current collecting layer 31 or an air electrode current collecting layer 32 are prepared with the use of the same compositions as a fuel electrode layer 11 and an air electrode layer 13. An interlayer 18 is placed between the electron flow channel section 15 and the fuel electrode layer 11, specifically between the electron flow channel section 15 and the fuel electrode current collecting layer 31. The interlayer 18 is formed with the use of a titanium based perovskite represented by A₁₋ₓBₓTi_{1-y}C_{y}O₃ (in the formula, A represents at least one selected from the group consisting of Sr, Ca, and Ba; B represents a rare-earth element; C represents Nb or Ta; and x and y represents a molar ratio, and 0≦x≦0.5 and 0≦y≦0.5), for example, SrTiO₃.

In this way, for the purpose of preventing a reaction of Fe contained in the electron flow channel section 15 with Ni contained in the fuel electrode layer 11 and fuel electrode current collecting layer 31 when the electron flow channel sections 15 composed of the ceramic composition represented by the composition formula La(Fe₁₋ₓAlₓ)O₃ are subjected to co-sintering with the fuel electrode layer 11 and the fuel electrode current collecting layer 31 containing nickel, the interlayer 18 composed of a titanium based perovskite oxide represented by, for example, SrTiO₃ is placed between the both. In this case, the electron flow channel sections 15 are formed to have high conductivity, in other words, have a large electrical resistance value, and to be dense so as to prevent the passage of the air and fuel gas. The material for forming the interlayer 18 does not have to be dense, and may be porous.

The placement of the interlayer 18 composed of a titanium based perovskite between the electron flow channel section 15 composed of the ceramic composition represented by the composition formula La(Fe₁₋ₓAlₓ)O₃ and the fuel electrode layer 11 and fuel electrode current collecting layer 31 containing nickel as described above is based on the following finding of the inventor.

When the electron flow channel section 15 composed of the ceramic composition represented by the composition formula La(Fe₁₋ₓAlₓ)O₃ and the fuel electrode layer 11 containing nickel were bonded by co-sintering, the Fe reacted with the Ni to produce LaAlO₃ lacking Fe at the bonded section (interface). The production of the LaAlO₃ which has a low conductivity interferes with the electrical junction between the electron flow channel section 15 composed of the ceramic composition represented by the composition formula La(Fe₁₋ₓAlₓ)O₃ and the fuel electrode layer 11 containing nickel. Therefore, the placement of the interlayer 18 composed of a titanium based perovskite oxide with the conductivity (the reciprocal of electrical resistance) increased under a fuel atmosphere, for example, SrTiO₃ has achieved a favorable electrical connection. This is because, for example, SrTiO₃ that is a type of A₁₋ₓBₓTi_{1-y}C_{y}O₃ (in the formula, A represents at least one selected from the group consisting of Sr, Ca, and Ba; B represents a rare-earth element; C represents Nb or Ta; and x and y represent a molar ratio, and 0≦x≦0.5 and 0≦y≦0.5) for forming the interlayer 18 forms no high-resistance layer, even when the SrTiO₃ is subjected to co-sintering with the electron flow channel section 15 composed of the ceramic composition represented by the composition formula La(Fe₁₋ₓAlₓ)O₃ and the fuel electrode layer 11 containing nickel.

The solid electrolyte fuel cell 1 as another embodiment of the present invention is manufactured as follows.

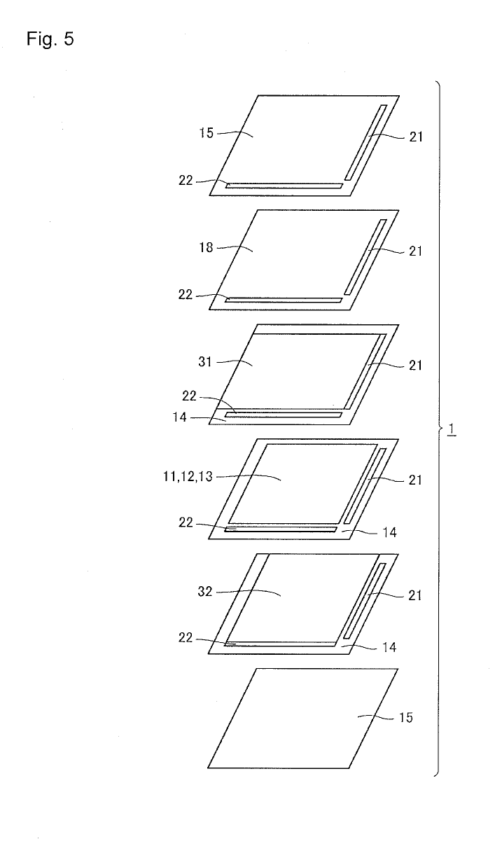

First, green sheets for main body sections 14 are each, as indicated by a dashed line in FIG. 4, subjected to punching with the use of a mechanical puncher to form elongated through holes 21a, 22a for forming a fuel gas supply channel 21 and an air supply channel 22 as shown in FIG. 5.

In addition, mating sections 11a, 12a, 13a respectively for fitting green sheets for a fuel electrode layer 11, a solid electrolyte layer 12, and an air electrode layer 13 are formed in a green sheet for the main body section 14 with the fuel electrode layer 11, solid electrolyte layer 12, and air electrode layer 13 to be placed thereon.

Furthermore, mating sections 31a, 32a respectively for fitting the green sheets for a fuel electrode current collecting layer 31 and an air electrode current collecting layer 32 are formed in the green sheets for the main body sections 14 with the fuel electrode current collecting layer 31 or air electrode current collecting layer 32 to be placed thereon. It is to be noted that the green sheets for the fuel electrode current collecting layer 31 or the air electrode current collecting layer 32 are prepared with the use of the same compositions as the respective material powders of the fuel electrode layer 11 and air electrode layer 13.

Moreover, green sheets for electron flow channel sections 15 and an interlayer 18 are each, as indicated by a dashed line in FIG. 4, subjected to punching with the use of a mechanical puncher to form elongated through holes 21a, 22a for forming a fuel gas supply channel 21 and an air supply channel 22 as shown in FIG. 5.

For each of the green sheets for the main body sections 14, which are prepared in the way described above, the green sheets for the fuel electrode layer 11, solid electrolyte layer 12, and air electrode layer 13 and the green sheets for the fuel electrode current collecting layer 31 and air electrode current collecting layer 32 are respectively fitted in the mating sections 11a, 12a, 13a and the mating sections 31a, 32a. The electron flow channel sections 15 and the interlayer 18 are, as shown in FIG. 5, stacked sequentially on the three green sheets obtained in this way.

The stacked sheets are subjected to pressure bonding by warm isostatic pressing (WIP) at a predetermined pressure and a predetermined temperature for a predetermined period of time. This pressure-bonded body is subjected to a degreasing treatment within a predetermined temperature range, and then to sintering by keeping at a predetermined temperature for a predetermined period of time.

In this way, the solid electrolyte fuel cell 1 is manufactured as another embodiment of the present invention.

It is to be noted that while the entire electrical conductor for electrically connecting the plurality of cells to each other is composed of the electron flow channel sections 15 formed from a material for the electron flow channel sections as shown in FIG. 3 or 6 in the embodiments described above, the electrical conductor may be partially formed from a material for the electron flow channel sections.

FIGS. 7 to 9 are cross-sectional views schematically illustrating cross sections of plate-like solid electrolyte fuel cells as several examples of forming an electrical conductor partially from a material for an electron flow channel section.

As shown in FIG. 7, the structural body is composed of main body sections 14 composed of electrical insulators for separating between a fuel gas as an anode gas and the air as a cathode gas, which are supplied to each of the cell; electron flow channel sections 15 formed in the main body sections 14, and composed of the material for electron flow channel sections as electrical conductors for electrically connecting the plurality of cells to each other; and conductors 16 for electron flow channel sections, which are formed so as to be connected to the electron flow channel sections 15. The electron flow channel sections 15 are formed on the side of an air electrode layer 13, formed so as to come into contact with the air, and specifically formed so as to be connected through an air electrode current collecting layer 32 to the air electrode layer 13. The conductors 16 for electron flow channel sections are formed so as to come into contact with a fuel gas, specifically, formed through a fuel electrode current collecting layer 31 to a fuel electrode layer 11, and composed of a mixture of a nickel oxide (NiO) and an yttria stabilized zirconia (YSZ).

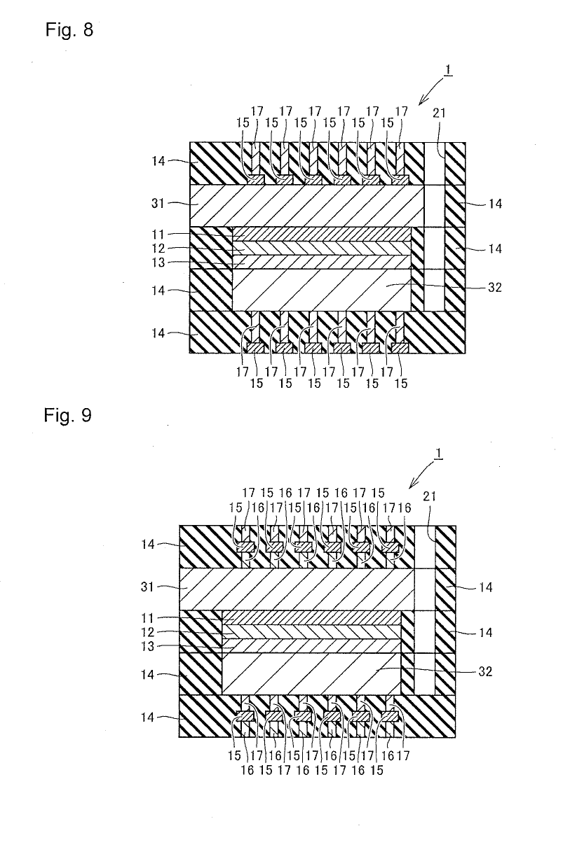

In addition, as shown in FIG. 8, the structural body is composed of main body sections 14 composed of electrical insulators for separating between a fuel gas as an anode gas and the air as a cathode gas, which are supplied to each of the cell; electron flow channel sections 15 formed in the main body sections 14, and composed of the material for electron flow channel sections according to the present invention as electrical conductors for electrically connecting the plurality of cells to each other; and conductors 17 for electron flow channel sections, which are formed so as to be connected to the electron flow channel sections 15. The electron flow channel sections 15 are formed on the side of a fuel electrode layer 11, formed so as to come into contact with a fuel gas, and specifically formed so as to be connected through a fuel electrode current collecting layer 31 to the fuel electrode layer 11. The conductors 17 for electron flow channel sections are formed so as to come into contact with the air, specifically formed so as to be connected through an air electrode current collecting layer 32 to an air electrode layer 13, and for example, composed of a mixture of a lanthanum manganite ((La,Sr)MnO₃) and an yttria stabilized zirconia (YSZ).

Furthermore, as shown in FIG. 9, the structural body is composed of main body sections 14 composed of electrical insulators for separating between a fuel gas as an anode gas and the air as a cathode gas, which are supplied to each of the cell; electron flow channel sections 15 formed in the main body sections 14, and composed of the material for electron flow channel sections as electrical conductors for electrically connecting the plurality of cells to each other; and conductors 16, 17 for electron flow channel sections, which are formed so as to be connected to the electron flow channel sections 15. The conductors 16 for electron flow channel sections are formed so as to come into contact with a fuel gas, specifically, formed through a fuel electrode current collecting layer 31 to a fuel electrode layer 11, and composed of a mixture of a nickel oxide (NiO) and an yttria stabilized zirconia (YSZ). The conductors 17 for electron flow channel sections are formed so as to come into contact with the air, specifically formed so as to be connected through an air electrode current collecting layer 32 to an air electrode layer 13, and for example, composed of a mixture of a lanthanum manganite ((La,Sr)MnO₃) and an yttria stabilized zirconia (YSZ). The electron flow channel sections 15 are formed so as to make connections between the conductors 16 and 17 for electron flow channel sections.

As described above, the electron flow channel sections 15 formed from the material for electron flow channel sections as shown in FIGS. 7 to 9 may be formed on the side of the fuel electrode layer 11 as an anode layer or the air electrode layer 13 as a cathode layer as shown in FIG. 7 or 8, and formed so as to come into contact with a fuel gas as an anode gas or the air as a cathode gas, or may be formed in middle sections of the electrical conductors as shown in FIG. 9.

With this configuration, the reduction in size of the sections formed from the material for electron flow channel sections, as dense sections which block gas permeation, can relax thermal stress caused in the production of the structural body (during co-firing) or during the operation of the solid electrolyte fuel cell. In addition, a material which has a further smaller electrical resistance than that of the material for electron flow channel sections can be selected and used as the material constituting the electron flow channels in the electrical conductors described above.

For example, green sheets for the structural body as shown in FIG. 7 are manufactured in the following way. First, green sheets for the main body sections 14 are prepared. Through holes are formed in the green sheets for the main body sections 14, and filled with a paste of a nickel oxide (NiO) mixed with 8 mol % of yttria stabilized zirconia. This paste is prepared by mixing, in blending proportions, 80 parts by weight of NiO, 20 parts by weight of YSZ, and 60 parts by weight of vehicle, and kneading the mixture with the use of a three-roll kneader. A mixture of ethyl cellulose and a solvent is used for the vehicle. On the other hand, green sheets for the electron flow channel sections 15 are prepared. Then, the green sheets for the electron flow channel sections 15 are cut into a disk shape as shown in FIG. 1, so as to have a larger diameter than the through holes, and the disk-shaped green sheets for the electron flow channel sections 15 are subjected to pressure bonding to the air electrode side of the through hole sections in the green sheets for the main body sections 14. It is to be noted that in order to prepare the green sheets for the structural body for separation between cells as shown in FIG. 6, two green sheets for the main body sections 14 are prepared, and pressure bonding is carried out in such a way that the disk-shaped green sheets for the electron flow channel sections 15 are sandwiched between the two green sheets for the main body sections 14.

### EXAMPLES

Examples of the present invention will be described below.

First, composite oxides of a strontium titanate (SrTiO₃) and an aluminum oxide (Al₂O₃) were prepared in various compositional proportions as high-temperature structural materials in the following way, and respective samples were evaluated.

(Preparation of Sample of High-Temperature Structural Material)

A SrTiO₃ powder and an Al₂O₃ powder were prepared as raw materials. These raw materials were weighed so as to achieve SrTiO₃: Al₂O₃=1−x:x in terms of mole fraction. The value of x is shown in Tables 1 to 5. For samples according to Examples 1 to 5 and Comparative Examples 1 to 3 and 5 shown in Table 1, the SrTiO₃ powder and the Al₂O₃ powder were mixed with an organic solvent and a polyvinyl butyral based binder to prepare a slurry. For a sample according to Comparative Example 4 shown in Table 1, only the SrTiO₃ powder was mixed with an organic solvent and a polyvinyl butyral based binder to prepare a slurry. For samples according to Examples 6 to 25 shown in Tables 2 to 5, the SrTiO₃ powder and the Al₂O₃ powder with a manganese oxide (Mn₃O₄) powder or a niobium oxide (Nb₂O₅) powder added thereto as a sintering aid in terms of weight % as shown in Tables 2 to 5 were mixed with an organic solvent and a polyvinyl butyral based binder to prepare a slurry.

Each obtained slurry was used to form green sheets by a doctor blade method. For the samples according to Examples 1 to 5 and Comparative Examples 1 to 5, the obtained green sheets were subjected to degreasing at a temperature of 400 to 500° C., and then to sintering at a temperature of 1400° C. for 4 hours to prepare sintered bodies. For the samples according to Examples 6 to 15, the obtained green sheets were subjected to degreasing at a temperature of 400 to 500° C., and then to sintering at a temperature of 1300° C. for 4 hours to prepare sintered bodies. For the samples according to Examples 16 to 20, the obtained green sheets were subjected to degreasing at a temperature of 400 to 500° C., and then to sintering at a temperature of 1260° C. for 6 hours to prepare sintered bodies. For the samples according to Examples 21 to 23, the obtained green sheets were subjected to degreasing at a temperature of 400 to 500° C., and then to sintering at a temperature of 1240° C. for 6 hours to prepare sintered bodies. For the samples according to Examples 24 to 25, the obtained green sheets were subjected to degreasing at a temperature of 400 to 500° C., and then to sintering at a temperature of 1230° C. for 6 hours to prepare sintered bodies.

The following evaluations (1) to (3) were made on the obtained samples according to Examples 1 to 5 and Comparative Examples 1 to 5. The following evaluations (2) to (4) were made on the samples according to Examples 6 to 15. The following evaluation (4) was made on the sintered body samples according to Examples 16 to 25.

(Evaluation on Sample of High-Temperature Structural Material)

Coefficient of Thermal Expansion

For each sample, the coefficient of thermal expansion in the elevated temperature process from 30° C. to 1000° C. was measured by a method with a thermal analysis instrument.

(2) Bending Strength (Deflecting Strength)

The bending strength for each sample was measured after the sintering and after reduction. A measurement sample on the order of 1 mm in thickness and on the order of 3 mm in width was prepared, and the bending strength thereof was measured by three-point bending with a span of 30 mm. The measurement was carried out on ten samples, and the average of the measurement values was calculated. The measurement on the reduced sample was carried out after applying a heat treatment to the sintered sample at a temperature of 900° C. for 16 hours in a reducing atmosphere containing 15 volume % of H₂O with a volume ratio of 2:1 between H₂ gas and N₂ gas.

(3) Bonding Property

Each sample of the green sheet of 200 μm in thickness after the degreasing and 8YSZ (zirconia (ZrO₂) partially stabilized with the addition of 8 mol % of yttria (Y₂O₃)) of a green sheet of 200 μm in thickness were cut into 65 mm×50 mm□, and subjected to pressure bonding. This pressure-bonded body was subjected to sintering at a temperature of 1400° C. to confirm and evaluate whether or not there is peeling or cracking. The case of the high-temperature structural material and 8YSZ bonded strongly without causing peeling or cracking was evaluated as “0”, whereas the case of peeling or cracking caused to result in a failure to bond the high-temperature structural material and the 8YSZ was evaluated as “x”. It is to be noted that the green sheet of 8YSZ was obtained by mixing a 8YSZ powder with an organic solvent and a polyvinyl butyral based binder to prepare a slurry, and using this slurry to form the green sheet by a doctor blade method.

(4) Relative Density

The density of each sintered sample was measured by an Archimedes method. The measurement was carried out on five samples, and the average of the measurement values was calculated.

The above evaluation results are shown in Tables 1 to 5.

TABLE 1

| | | Coefficient | | | |
|---|---|---|---|---|---|
| | | of Thermal | Bending | Bending | Bonding |
| | | Expansion | Strength | Strength | to |
| | Al₂O₃ | 30 to | (after | (after | YSZ |
| | Content | 1000° C. | sintering) | reduction) | ∘ possible x |
| | x | × 10⁻⁶/K | × 10² MPa | × 10² MPa | impossible |
| Example 1 | 0.1 | 11.03 | 1.7 | 1.7 | ∘ |
| Example 2 | 0.15 | 10.86 | 1.8 | 1.8 | ∘ |
| Example 3 | 0.2 | 10.74 | 2.3 | 2.3 | ∘ |
| Example 4 | 0.3 | 10.41 | 2.9 | 2.9 | ∘ |
| Example 5 | 0.37 | 9.86 | 3.2 | 3.2 | ∘ |
| Comparative | 0.05 | 11.26 | 1.7 | 1.7 | x |
| Example 1 | | | | | |
| Comparative | 0.4 | 9.7 | 3.3 | 3.3 | x |
| Example 2 | | | | | |
| Comparative | 0.6 | 9.25 | 3.6 | 3.6 | x |
| Example 3 | | | | | |
| Comparative | 0 | 11.6 | 1.7 | 1.7 | x |
| Example 4 | | | | | |
| Comparative | 1 | 9 | 4 | 4 | x |
| Example 5 | | | | | |

TABLE 2

| | | | | Relative | Bending | Bending | Bonding to |
|---|---|---|---|---|---|---|---|
| | | | | Density | Strength | Strength | YSZ |
| | Al₂O₃ | Mn₃O₄ | Nb₂O₅ | (sintering | (after | (after | ◯ |
| | Content | Content | Content | at 1300° C.) | sintering) | reduction) | possible x |
| | x | wt % | wt % | % | ×10² MPa | ×10² MPa | impossible |
| Example 6 | 0.1 | 1.5 | 0 | 98 | 1.7 | 1.7 | ◯ |
| Example 7 | 0.15 | 1.5 | 0 | 97 | 1.8 | 1.8 | ◯ |
| Example 8 | 0.2 | 1.5 | 0 | 95 | 2.2 | 2.2 | ◯ |
| Example 9 | 0.3 | 1.9 | 0 | 96 | 2.9 | 2.9 | ◯ |
| Example 10 | 0.37 | 1.9 | 0 | 93 | 2.7 | 2.7 | ◯ |
| Example 11 | 0.1 | 0 | 2.7 | 98 | 1.7 | 1.7 | ◯ |
| Example 12 | 0.15 | 0 | 2.7 | 97 | 1.8 | 1.8 | ◯ |
| Example 13 | 0.2 | 0 | 2.7 | 97 | 2.3 | 2.3 | ◯ |
| Example 14 | 0.3 | 0 | 3.2 | 96 | 2.9 | 2.9 | ◯ |
| Example 15 | 0.37 | 0 | 3.2 | 95 | 3.1 | 3.1 | ◯ |

TABLE 3

| | | | Relative Density |
|---|---|---|---|
| | Al₂O₃ | Nb₂O₅ | (sintering at |
| | Content | Content | 1260° C.) |
| | x | wt % | % |
| Example 16 | 0.2 | 2.7 | 97 |
| Example 17 | 0.2 | 3.2 | 99 |
| Example 18 | 0.2 | 4.1 | 97 |
| Example 19 | 0.3 | 2.7 | 97 |
| Example 20 | 0.2 | 1.4 | 95 |

TABLE 4

| | | | Relative Density |
|---|---|---|---|
| | Al₂O₃ | Nb₂O₅ | (sintering at |
| | Content | Content | 1240° C.) |
| | x | wt % | % |
| Example 21 | 0.2 | 2.7 | 97 |
| Example 22 | 0.2 | 3.2 | 98 |
| Example 23 | 0.3 | 2.7 | 97 |

TABLE 5

| | | | Relative Density |
|---|---|---|---|
| | Al₂O₃ | Nb₂O₅ | (sintering at |
| | Content | Content | 1230° C.) |
| | x | wt % | % |
| Example 24 | 0.2 | 2.7 | 96 |
| Example 25 | 0.3 | 2.7 | 96 |

As shown in Table 1, in the case of the samples according to Examples 1 to 5 containing Al₂O₃ at 10 parts by mol or more and 37 parts by mol or less with respect to 100 parts by mol of the total of SrTiO₃ and Al₂O₃, in other words, in the case of the samples according to Examples 1 to 5 containing Al at 10 parts by mol or more and 60 parts by mol or less with respect to 100 parts by mol of SrTiO₃, the difference from 8YSZ in coefficient of thermal expansion is on the order of 0.6×10⁻⁶/K or less, and it is thus determined that the bonding property was favorable even in the case of co-firing with 8YSZ as a solid electrolyte material.

As shown in Tables 2 to 5, in the case of the samples according to Examples 6 to 25 with the high-temperature structural materials containing Mn₃O₄ or Nb₂O₅ as a sintering aid at 1.0 weight % or more and 5.0 weight % or less, the relative density is 93% or more for each of the samples in spite of the sintering at low temperatures of 1300° C. or less, and it is thus determined that dense sintered bodies were able to be achieved.

The embodiments and examples disclosed herein are by way of example in all respects, and to be considered non-limiting. The scope of the present invention is defined by the appended claims, not by the above embodiments and examples, and intended to encompass all modifications and variations within the spirit and scope equivalent to the claims.

It is possible to achieve a high-temperature structural material which not only has a coefficient of thermal expansion closed to the coefficient of thermal expansion of an electrolyte material, but also undergoes no decrease in mechanical strength even in a reducing atmosphere, and can be sintered at relatively low temperatures just by adding a predetermined sintering aid, a structural body for a solid electrolyte fuel cell, which is formed with the use of the high-temperature structural material, and a solid electrolyte fuel cell including the structural body.

### DESCRIPTION OF REFERENCE SYMBOLS

1: solid electrolyte fuel cell, 11: fuel electrode layer, 12: solid electrolyte layer, 13: air electrode layer, 14: main body section, 15: electron flow channel section

1. A high-temperature structural material containing strontium titanate and aluminum, wherein an amount of the aluminum in the high-temperature structural material is at 10 parts by mol or more and 60 parts by mol or less with respect to 100 parts by mol of the strontium titanate.

2. The high-temperature structural material according to claim 1, further comprising manganese oxide or niobium oxide.

3. The high-temperature structural material according to claim 2, wherein the manganese oxide or the niobium oxide is at 1.0 mass % or more and 5.0 mass % or less of the high-temperature structural material.

4. A structural body for a solid electrolyte fuel cell, the structural body comprising:
a main body section comprising an electrical insulator; and
an electron flow channel section in the main body section,
wherein the main body section is a high-temperature structural material that includes strontium titanate and aluminum, wherein an amount of the aluminum in the high-temperature structural material is at 10 parts by mol or more and 60 parts by mol or less with respect to 100 parts by mol of the strontium titanate.

5. The structural body for a solid electrolyte fuel cell according to claim 4, wherein the main body section and the electron flow channel section are co-sintered sections.

6. The structural body for a solid electrolyte fuel cell according to claim 4, further comprising manganese oxide or niobium oxide.

7. The structural body for a solid electrolyte fuel cell according to claim 6, wherein the manganese oxide or the niobium oxide is at 1.0 mass % or more and 5.0 mass % or less of the high-temperature structural material.

8. A solid electrolyte fuel cell comprising:
a plurality of cells each composed of an anode layer, a solid electrolyte layer, and a cathode layer stacked sequentially; and
a structural body between or around the plurality of cells, the structural body comprising strontium titanate and aluminum, wherein an amount of the aluminum in the high-temperature structural material is at 10 parts by mol or more and 60 parts by mol or less with respect to 100 parts by mol of the strontium titanate.

9. The solid electrolyte fuel cell according to claim 8, wherein the structural body further comprises manganese oxide or niobium oxide.

10. The solid electrolyte fuel cell according to claim 9, wherein the manganese oxide or the niobium oxide is at 1.0 mass % or more and 5.0 mass % or less of the structural body.
